(19) United States
(12) Patent Application Publication
(10) Pub. No.: US 2005/0026001 A1
(43) Pub. Date: Feb. 3, 2005

(54) Shielded ceramic thermal spray coating

(76) Inventor: Thomas A. Taylor, Indianapolis, IN (US)

Correspondence Address: PRAXAIR, INC.;LAW DEPT - M1557, 39 OLD RIDGEBURY ROAD, DANBURY, CT, 06810-5113, US

(21) Appl. No.: 10/630,658

(22) Filed: Jul. 31, 2003

(51) Int. Cl. H05H 1/26; B32B 9/00

(52) U.S. Cl. 428/701; 427/446; 428/702

(57) ABSTRACT

This invention provides a unique method of thermally spraying high melting point material, such as ceramic materials, at an extended standoff using a gas shield and producing microstructure properties having the same properties using a short standoff without a gas shield. It is particularly useful for controlling the microstructure of a ceramic coating at an extended standoff to facilitate the coating of components with a complex shape.

### FIELD OF THE INVENTION

This invention relates generally to the field of thermal spray of ceramic materials particularly useful for spraying ceramic materials at extended standoffs.

### BACKGROUND OF THE INVENTION

In thermal spray deposition, material in powder, wire, or rod form is heated to near its melting point or just above and the molten or nearly molten particles accelerated in a gas stream to a high velocity before impacting on the surface to be coated, the substrate. On impact the particles flow into thin lamellar splats and rapidly freeze and cool. The coating is made up of many layers of splats. Materials such as metallic, ceramic, cermet, and some polymeric may be deposited by thermal spray methods. A variety of thermal spray devices may be used including plasma, detonation gun, high velocity oxy-fuel, wire arc, and flame spray. Of these, plasma spray is one of the best for the deposition of ceramics because of the very high temperatures generated in the plasma effluent. The coatings are usually produced by moving the thermal spray device relative to the part being coated to distribute the material uniformly over the surface in multiple passes producing a specific microstruction. This helps to control the temperature of the surface being coated and the residual stress in the coating. Thermal spray deposition processes and coatings are well known and have been described in detail in a number of references.

The most important parameters that determine the microstructure and properties of the coatings include the temperature of the particles, their velocity, the extent to which they have reacted with the environment during deposition, the rate of deposition, the angle of impact, and the temperature of the substrate and previously deposited coating. The particles are heated (with the exception of the wire arc process) and accelerated by the gaseous effluent of the thermal spray device thus the temperature and velocity achieved are a function, in part, of the dwell time in the effluent. The dwell time is determined by the velocity of the particles and the distance (called the standoff) between the exit of the thermal spray device and the substrate. The temperature and velocity of the effluent of the thermal spray device decrease fairly rapidly on exit from the device. Therefore, there is an optimum standoff that allows sufficient distance or time for the particles to be heated and accelerated, but not so great that the effluent and particle temperatures and velocities begin to decline significantly. The angle of impact can have a major influence on the microstructure and properties of the coating. Generally, the optimum angle is at 90 degrees or normal to the substrate. As the angle becomes lower, the microstructure becomes more turbulent and less dense. The rate at which this degradation occurs is a function, in part, of the velocity and temperature of the particles on impact. The effective standoff and the sensitivity to the angle of deposition are particularly important when thermal spraying components with a complex shape. Thermal spray is inherently a line of sight process, and the size of the thermal spray device and shape of the part being coated may limit how close the thermal spray device can be brought to the part and still maintain an allowable angle of deposition. Thus it may not be possible to bring the thermal spray device close enough to the surface to deposit the particles at a sufficient temperature, velocity, and angle of impact to produce a coating with a suitable microstructure.

The reaction of the particles with the environment during deposition that is of primary concern is oxidation. The effluent of a thermal spray device begins to mix with the surrounding environmental gases, usually air, immediately upon exiting the thermal spray device. If a reactive material is being deposited, such as most metals, polymeric materials, and, to a lesser extent, carbides and nitrides, the oxygen from the air being mixed with the thermal spray effluent can oxidize the material, significantly changing the microstructure properties of the coating. The longer the standoff, the greater the degree of oxidation. There are two major methods of avoiding this oxidation. One is to deposit the coating in a vacuum chamber under a low pressure of inert gas. In this situation the inert gas, usually argon, is drawn into the effluent rather than air, and no oxidation occurs. This technique has been well developed for plasma spray deposition and can be very effective. It has an additional benefit of a longer standoff due to the low pressure environment. The capital and operating costs of such a system are very high, however, and the production rate is low. The alternative is to provide a coaxial inert gas shield or shroud surrounding the effluent to prevent oxidation.

The most effective inert gas shield is that invented by Jackson, U.S. Pat. No. 3,470,347. This invention provides a uniform flow of turbulent inert gas, usually argon, surrounding the effluent of a plasma spray torch. It is very effective in preventing oxidation of reactive materials during deposition. Another invention provides a laminar gas shield by introducing a flow of inert gas normal to the thermal spray effluent within the thermal spray nozzle or an attachment to the thermal spray device through a porous medium arrayed parallel to the effluent such that the interaction with the thermal spray effluent creates the laminar layer of gas (M. S. Nowotarski, et al, U.S. Pat. No. 5,486,383). All of the known gas shields are used to prevent or reduce the amount of oxidation during deposition and are therefore used only when depositing materials that may be susceptible to oxidation.

Ceramic coatings can effectively be deposited by several thermal, particularly plasma spray, and are generally resistant to oxidation during deposition. They are, therefore, not deposited using gas shields. Ceramic coatings are used for many purposes, primarily for their corrosion resistance, wear resistance, electrical resistivity, or as thermal barriers. Thermal barrier coatings (TBCs) are used on gas turbine combustors, blades, vanes, and seal segments as well as on some internal combustion engine components.

There are many variations of thermal barrier coatings, based on the materials selected for the coating and the coating processes. Most TBCs include a metallic bondcoat applied to the metallic substrate component and, on top of the bondcoat, a ceramic layer, usually based on zirconium oxide because of its very low thermal conductivity compared to metallic alloys. The zirconia layer of the coating varies depending on the specific requirements; e.g., from about 0.25 mm (10 mils) on some turbine blades and vanes to over 2.5 mm (100 mils) or more on combustors. Yet the coating can reduce the substrate temperature by 200 or more degrees Fahrenheit (111 degrees Centigrade), depending on the hot and cold side boundary conditions. On blades and vanes, the TBC must protect the airfoil and usually the attachment platform or end walls. On combustors, the TBC is applied on the interior surfaces. The metallic bondcoat can be applied by various methods including thermal spray methods (e.g., shrouded and air-plasma torch, vacuum chamber plasma torch, detonation gun, or high velocity oxy-fuel gun), gas diffusion (such as pack aluminizing), and advanced methods of electroplating. The zirconia ceramic layer can be applied using various methods including thermal spray and electron beam physical vapor deposition (EB-PVD).

In the application of thermal spray coatings on complex shapes, such as turbine blades or vanes, there are several issues that affect the quality of the coating or sometimes even the possibility of applying the coating. Standoff is one such issue because it affects the microstructure of the coating including its porosity. A controlled porosity is essential to the thermal shock and thermal fatigue resistance of the oxide layer in a TBC. The shape of the part including protuberances (such as the vane platform edges) sets the minimum standoff that can be achieved. Sometimes this means the standoff to other areas, such as the airfoil, are at longer standoff than would normally be preferred.

Another issue in thermal spray is the local deposition rate of the coating; i.e., the amount of coating material deposited per unit time, per unit area. It is controlled, in part, by the surface speed at which the torch is moved over the part. The deposition rate is controlled in such a manner as to deposit the coating in thin layers to control the residual stress in the coating. In one particular case, the deposition rate and resulting layer thickness is used to control the stresses such that the zirconia coating is intentionally cracked in vertical, through-thickness segmentation cracks or cells (Taylor, U.S. Pat. No. 5,073,433). Surface speed is one of the process parameters precisely controlled to produce the desired layer thickness and a coating with specific crack spacing. With complex parts such as airfoils, it is usually not possible to control surface speed and standoff simultaneously around the part without robotic manipulation of the torch or the part. Robot manipulation is excellent for coating complex shapes, as long as the surface speed chosen is within the controlled speed range of the robot. This usually means that surface speeds must be lower for robotic applications of coatings, which may make it difficult or impossible to achieve the required set of deposition parameters.

In summary, state-of-the-art thermal spray processes are limited in their ability to deposit ceramic coatings, particularly oxide coatings, on some complex shapes with the desired microstructure, residual stress and other properties, in part due to the limited range of standoff and surface speeds required. Thus it would be very advantageous to have method of extending the allowable standoff for the thermal spray deposition of ceramic coatings.

### SUMMARY OF THE INVENTION

This invention provides a unique method of thermally spraying ceramic materials using a gas shield to produce a ceramic coating with a desired microstructure using an extended standoff that is at least 20% longer than the standoff of the thermal spray without a gas shield producing the same microstructure. Preferably, the standoff can be 50% longer than the standoff of a thermal spray without the gas shield. It is particularly useful for controlling the desired microstructure of a ceramic coating of components with a complex shape using the shielded thermal spray at an extended standoff. In summary, the standoff distance between the surface of the substrate and the exit end of a shielded thermal spray device is at least 20% longer than the standoff distance of a non-shielded thermal spray device and the shielded device producing a microstructure coated layer similar or identical to a microstructure coating that would be produced using the smaller standoff of the non-shielded device.

### DESCRIPTION OF THE PREFERRED EMBODIMENTS

Inert gas shields known in the art are used to prevent or reduce the oxidation of reactive materials such as metals during deposition. It would be thought by those skilled in the art to be nonsensical to use such a shield when spraying a material not sensitive to oxidation (or possibly nitridation). It has now been found, however, that there are additional benefits to be gained using such a shield. It has been discovered that when using such a shield the temperature of the thermal spray effluent is substantially higher close to the thermal spray device and the rate of temperature decline with distance from the device is substantially lower; i.e., the effluent temperature remains high for a longer distance. Moreover, it has been discovered that the temperature effect is sensitive to the flow rate of the shield gas, and that, surprisingly, it does not continuously increase with increasing flow rate, but that there is an optimum flow rate. This effect would not be expected by those skilled in the art. This is illustrated for a particular plasma spray torch using argon shield gas in Example 1. Obviously, the optimum flow rates and the particular temperature effects depend on the specific thermal spray process, the torch or gun operating parameters, and the shield gas nozzle design, gas composition, and flow rates. The optimum standoff to produce a desired microstructure was limited due to the decrease in temperature of the particles contacting the substrate. This resulted in the standoff being rather close to the substrate. This limited the thermal spray coating to simple shapes and not effective for components with complex shapes.

Surprisingly, it has been discovered that by using a gas shield when thermally spraying a high melting material such as ceramic or nonreactive materials such as oxides, but also including nitrides, carbides, and other ceramic and nonreactive materials, that the standoff can be extended without degradation of the microstructure or other properties of the coating. A high melting material is one having a melting point of greater than 2800° F. (1538° C.). Alternatively, coatings with a higher density, higher deposition efficiency, higher deposition rate, and more uniform microstructure can be achieved at the extended standoff. These type of coatings would be expected to have greater wear resistance, erosion resistance, higher bond strength, and other desirable properties. These effects are thought to be due to the increased and extended temperature effect due to the shield on the thermal spray effluent. The efficacy of this discovery is illustrated in Example 2 below using zirconium oxide. It was shown that the microstructures required for TBCs could be obtained at significantly longer standoffs with a shield than without. Moreover, at a given standoff, the microstructures were more uniform, the coatings denser, and the deposition efficiency higher with a shield than without.

While yttria, partially stabilized zirconia, was used in the example, the invention applies to other zirconia compounds, other oxides, nitrides, carbides, and other refractory materials or compounds or mixtures thereof. The invention also applies to multilayer and continuously graded ceramic coatings in composition, microstructure, or both. Similarly, while the zirconia coatings in the example were designed to be used as TBCs on gas turbine components, they can be used on the components of internal combustion engines. The invention also applies to the use of thermally sprayed ceramics on other components and for other purposes including, but not limited to wear resistance, abradability, corrosion resistance, electrical and electronic functions, and for their optical properties. In addition, while the examples relate to plasma spray using a particular type of plasma spray device, particular operating parameters for this-device, particular shield designs and operating parameters for those shield designs, the invention applies to other types of plasma spray devices, other types of thermal spray devices, other shield designs, and other operating parameters for the thermal spray devices and shields. While argon has been found to be particularly effective as a shield gas, other gases including nitrogen and air can be used.

### EXAMPLE 1

A series of experiments were made with a Model 1108 Praxair plasma torch with a gas shield. The shield comprised a flat porous metal disc with an inside diameter of about 1.0 inches and an outside diameter of 1.4 inches surrounding and in the plane of the nozzle of the plasma spray torch. The shield had a 0.75 inch long hollow cylinder or wall projecting normal to the porous metal disc to further channel the gas flowing through the disc coaxially with the plasma effluent. The downstream temperature of the hot gas effluent was mapped with thermocouples. A metal ring-shaped fixture that held twelve type K thermocouples at different radial distances from the center of the ring was made. The ring was aligned to have its center on the centerline of the torch effluent and was moved to different distances downstream from the torch during the data collection. The temperatures were plotted as a function of the radial and downstream distances relative to the torch body. The data was collected from 1 to 6 inches downstream. Measurements closer than 1 inch from the face of the torch were not possible because the temperatures were too high for the thermocouples used. With the shielded torch it was necessary keep the thermocouples even further from the torch; e.g., 1.5 inches with the torch operating parameters used for MCrAlY coatings and 3.0 inches for torch conditions used for zirconia coatings when both were using an argon shield gas flow of 3000 cfh.

It was found that the radial temperature distribution at any fixed downstream distance was a Gaussian distribution. The temperature of the hot gas was naturally highest along the centerline of the effluent, which corresponded to the peaks of the Gaussian curves. The centerline temperatures were measured and plotted as a function of the distance downstream from the torch under several operating conditions, and several findings were made regarding the effect of adding an gas shield to the torch. Shielding gas flow greatly increased the temperatures at short distances from the torch and held higher temperatures to much longer standoff distances than the unshielded torch. The centerline temperature data was found to fit a hyperbolic function of the standoff distance,
T=[m/SO]+b
where “SO” is the distance from the exit plane of the torch effluent and “m” and “b” are constants. The values of m and b were, of course, different for each different torch operating condition (such as torch current and torch gas flow and gas mixture) and for each different shield gas condition (such as flow rate and gas type).

As an example, running the torch at 150 amps with 180 cfh argon torch gas with 40 cfh hydrogen added, the centerline temperatures at 1 to 4 inches were measured with various argon and air shield gas flows as shown below.

### Effect of Room Temperature Co-axial Gas Shield on Plasma Torch Centerline Effluent Temperature

Conditions:
PST Model 1108 plasma torch
150 amps, 180 cfh argon +40 cfh hydrogen torch gas

Porous metal shield gas annulus

| | | Distance downstream from torch body (inches) | | | |
|---|---|---|---|---|---|
| Shield flow, cfh | | 1 | 2 | 3 | 4 |
| | | Temperature ° F. | | | |
| 0 | | 2375 | 1475 | 1120 | 708 |
| 500 | Ar | * | * | 2330 | 1746 |
| 3000 | Ar | * | * | 2186 | 1780 |
| 500 | air | * | 2406 | 1582 | 1198 |

*At these closer standoff distances, gas temperature was above type K thermocouple measurement limit.

The centerline temperature at 1 inch standoff distance was found to be 5,000° F. higher with a turbulent 500 cfh coaxial argon shield flow than with zero shield flow. In this case, the temperature was extrapolated to the 1 inch position by using the hyperbolic fit equation for the shielded flow, because they were much higher than type K thermocouples would be able to read directly. In every case, the fit to the available data was very good and the extrapolations considered reasonable. At 2 inches downstream the shielded torch gas effluent was 3000° F. hotter at centerline than without the shield, and at 4 inches almost 1000° F. hotter. Another finding was that an argon shield flow of 500 cfh resulted in higher centerline temperatures than a 3000 cfh shield flow. Thus there is an optimum shield flow for the temperature effect desired. It was also found that argon was much more effective than air as a shield gas at the same flow rate.

The higher downstream temperatures obtained with the shielded effluent act to reduce the cooling rate of the particles melted by the plasma torch, and thus allow a denser coating to be deposited at longer standoff than without shielding. The shielding effect when thermal spraying ceramic materials is at least two-fold, maintaining the thermal spray gas temperatures for a longer distance from the nozzle of the thermal spray device thus providing more heat and time for melting the ceramic spray particles and providing more kinetic energy in the gas stream for more distance or time to accelerate the ceramic particles, both effects contributing to better coatings at longer torch to substrate standoff distances. One additional benefit of longer standoff is usually lower residual stress, since the coating is spread to a thinner layer due to a wider spray pattern at longer standoff.

### EXAMPLE 2

Zirconium oxide coatings were produced with and without the use of an ambient temperature argon gas shield similar to the shield in Example 1, but with an extension 0.56 inch long. The standoff for both were 0.75 inches. It was found that those produced with the gas shield with a flow of 500 cfh argon had a higher density than those without the shield, 92.3 versus 91.8 percent. The deposition efficiency was increased from 35 to 38 percent, and the deposition rate increased from 220 to 240 mil square inch per minute. This led to a higher segmentation crack density, a desirable effect for thermal shock and thermal fatigue resistance. The use of the shield also produced coatings with a more uniform microstructure than those produced without a gas shield at the same standoff. Alternatively, this effect would allow the same microstructure and density to be produced at a longer standoff with a gas shroud than without. It was also found that a shield gas flow of 500 cfh argon produced better results than a flow of 1000 cfh. These were all surprising results, since previously gas shrouds were used only to prevent oxidation of reactive metals during deposition.

The normal standoff for zirconium oxide coatings with segmentation cracks produced without a gas shield is about 1.0 inch. It has been found that the standoff can be increased to at least about 1.5 inches using a gas shield as described above, without changing the microstructure including the coating density or segmentation crack density. This approximately 50% increase in standoff makes it possible to coat components such as gas turbine blades and vanes with a more complex shape than was previously possible.

Other variations of the disclosed methods are within the intended scope of this invention as claimed below. As previously stated, detailed embodiments of the present invention are disclosed herein; however, it is to be understood that the disclosed embodiments are merely exemplary of the invention that may be embodied in various forms.

1. A method of thermal spraying a material comprising thermal spraying said material from a thermal spray device with a coaxial gas shield having a shield gas flow substantially surrounding the effluent of the thermal spray device to produce a desired microstructure coating on at least a portion of the surface of a substrate and a standoff distance between the surface of the substrate and the exit end of the shielded thermal spray device is at least 20% longer than the standoff distance of a non-shielded thermal spray device and said shielded gas flowing thermal spraying producing a microstructure coating similar to a microstructure coating that would be produced using the smaller standoff of the non-shielded thermal spraying device.

2. The method of claim 1 wherein the material is a ceramic.

3. The method of claim 1 wherein the standoff distance is at least 50% longer.

4. The method of claim 1 wherein the coaxial shield gas flow is an essentially turbulent gas flow substantially surrounding the effluent of the thermal spray device.

5. The method of claim 3 wherein the coaxial shield gas flow is an essentially turbulent gas flow substantially surrounding the effluent of the thermal spray device.

6. The method of claim 2 wherein said ceramic material is an oxide.

7. The method of claim 6 wherein said oxide is zirconia or a compound containing zirconia.

8. The method of claim 2 wherein said coating comprises layers of the ceramic material.

9. The method of claims 2 wherein said gas used in the coaxial gas shield is selected from the group consisting of argon, nitrogen, air and mixtures thereof.

10. The method of claim 9 wherein the gas is argon.

11. The method of claim 3 wherein the material is a ceramic material.

12. The method of claim 11 wherein said ceramic is zirconia or a compound containing zirconia.

13. The method of claim 11 wherein said coating comprises layers of the ceramic material.

14. A coated article having a coated layer wherein the coated layer is produced by the method of claim 1.

15. The coated article of claim 14 wherein the coating is a ceramic material.

16. The coated article of claim 14 wherein said article is a component of a gas turbine engine.

17. The coated article of claim 15 wherein said article is a component of an internal combustion engine.

18. The coated article of claim 15 wherein the coated layer is produced by the method of claim 3.

19. The coated article of claim 18 wherein said article is a component of a gas turbine engine.

20. The coated article of claim 18 wherein said article is a component of an internal combustion engine.
